(19) United States
(12) Patent Application Publication
(10) Pub. No.: US 2004/0083461 A1
(43) Pub. Date: Apr. 29, 2004

(54) Method for disassembling of micro-controller

(76) Inventor: Ryuji Kosaka, Miyazaki (JP)

Correspondence Address: RABIN & Berdo, PC, 1101 14TH STREET, NW, SUITE 500, WASHINGTON, DC, 20005, US

(21) Appl. No.: 10/282,104

(22) Filed: Oct. 29, 2002

(51) Int. Cl. G06F 9/45; G06F 9/44

(52) U.S. Cl. 717/136; 717/124; 712/208

(57) ABSTRACT

When a disassemble window is scrolled upwardly, it will go back by one address, and it will carry out disassemble of the address, and the corresponding command is displayed. A method for disassembling command code of a micro-controller according to the present invention includes 1) displaying information comprising addresses, command codes and disassembled commands, in which (N)th to (N+n)th addresses are displayed; and 2) performing a disassembling process to a command code corresponding to a (N−1)th address.

### TECHNICAL FIELD OF THE INVENTION

The present invention relates to a method for disassembling of a micro-controller, which includes a scroll window or disassemble window. The present invention also relates to debugger and simulator using such a method or program.

### BACKGROUND OF THE INVENTION

FIG. 1 is a diagram showing a conventional system for debugging. The system includes an in-circuit emulator 1 and a debugger 4. The in-circuit emulator 1 includes a code memory 2. The debugger 4 includes a disassemble window 5. The in-circuit emulator 1 and the debugger 4 are connected via a communication cable 3.

As shown in FIG. 1, the disassemble window 5 transforms or converts the contents of the code memory 2 of the in-circuit emulator 1 into commands of a micro-controller. The disassemble window 5 displays the transformed data on it.

FIG. 2 is a diagrams showing a simulator 6 including a code memory buffer 7 and a disassemble window 8. The disassemble window 8 transforms or converts the contents of the code memory buffer 7 into commands of a micro-controller. The disassemble window 8 displays the transformed data on it.

When a command of a micro-controller is not represented or defined by a single address data, the command is represented by a plurality of address of data.

FIG. 3 shows a disassemble window 9 (5 or 8), which includes a cursor 10. This cursor 10 can be scrolled up and down with the vertical arrow key of a keyboard, or the vertical direction buttons 12 and 13 on a scroll bar 11. When making the cursor 10 of the disassemble window 9 scroll upward, all the codes from the first address of the code memory 2 or the code memory buffer 7 to the address currently displayed on the disassemble windows 9 (5 or 8) to turn, and displays the corresponding commands. Scrolling upward is moving cursor in the direction of the address to the small large address.

According to the conventional processing, all the codes are disassembled to turn from the first address of the code memory, even when scrolling to one-line above. Therefore, the number of times of disassemble processing increases remarkably. Especially, near the address of the last of the code memory, display velocity becomes extremely slow for this reason.

### OBJECTS OF THE INVENTION

Accordingly, it is an object of the present invention to provide a method for disassembling a micro-controller, in which display velocity of a disassemble window can be increased.

Additional objects, advantages and novel features of the present invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

According to a first aspect of the present invention, a method for disassembling command code of a micro-controller including the steps of: displaying information comprising addresses, command codes and disassembled commands, in which (N)th to (N+n)th addresses are displayed and performing a disassembling process to a command code corresponding to a (N−1)th address.

According to a second aspect of the present invention, a method for disassembling command code of a micro-controller including the steps of: displaying information comprising addresses, command codes and disassembled commands, in which (N)th to (N+n)th addresses are displayed; and starting a disassembling process with a command code corresponding to an address “A” steps prior to the (N)th address. “A” is the maximum number of command codes of the micro-controller.

According to a third aspect of the present invention, a method for disassembling command code of a micro-controller including the steps of: displaying information comprising addresses, command codes and disassembled commands; providing program which comprises a command codes and an address; providing a print file, which comprising data corresponding to the displayed information; generating a command head information in accordance with the print file; and generating a start address for a disassemble process in accordance with the command head information.

### BRIEF DESCRIPTION OF THE DRAWINGS

FIG. 1 is a diagram showing a conventional system performing a disassembling process.

FIG. 2 is a diagram showing a conventional simulator of a micro-controller.

FIG. 3 is a diagram illustrating a disassemble window.

FIG. 4 is a diagram showing contents of a code memory according to a first preferred embodiment of the present invention.

FIG. 5 is a flow chart showing an operation of a first preferred embodiment of the present invention.

FIG. 6 is a diagram showing an operation of the first preferred embodiment.

FIG. 7 is a flow chart showing an operation of a second preferred embodiment of the present invention.

FIG. 8 is a diagram showing a system according to a third preferred embodiment of the present invention.

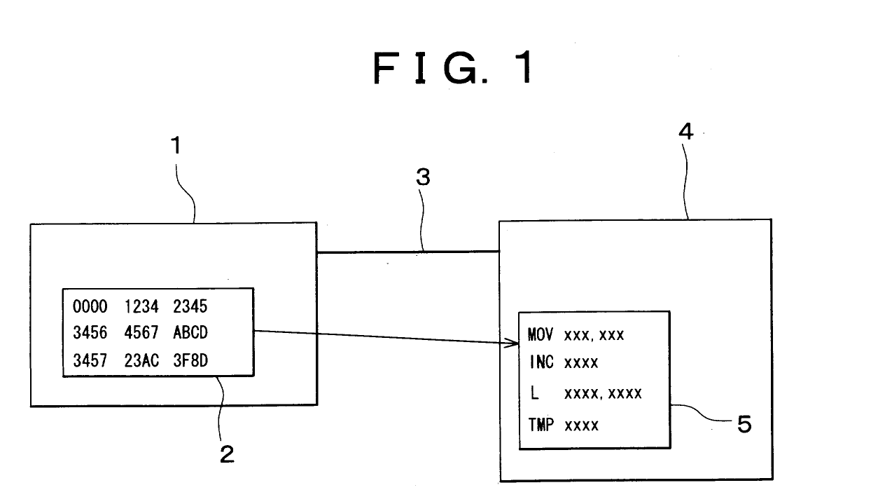

### DETAILED DISCLOSURE OF THE INVENTION

In the following detailed description of the preferred embodiments, reference is made to the accompanying drawings which form a part hereof, and in which is shown by way of illustration specific preferred embodiments in which the inventions may be practiced. These preferred embodiments are described in sufficient detail to enable those skilled in the art to practice the invention, and it is to be understood that other preferred embodiments may be utilized and that logical, mechanical and electrical changes may be made without departing from the spirit and scope of the present inventions. The following detailed description is, therefore, not to be taken in a limiting sense, and scope of the present inventions is defined only by the appended claims.

This invention relates to software, which carries out disassemble of instruction codes from a micro-controller, and displays the disassembled data on a window, which can scroll up and down. Moreover, this invention is applicable to the window type debugger connected to the in-circuit emulator of a micro-controller. Furthermore, this invention can apply operation of a micro-controller to the window type simulator, which can simulate on instruction level.

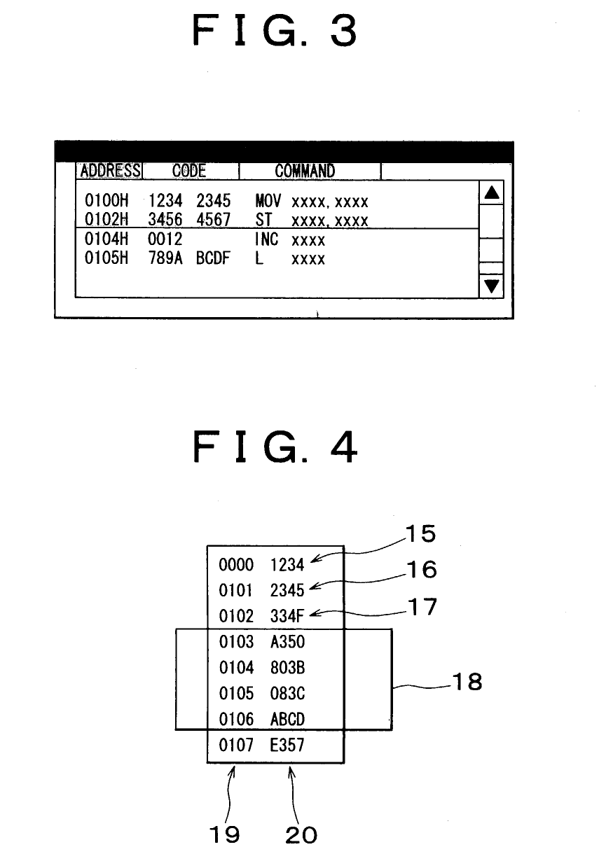

According to the present invention, in the disassemble window 9, shown in FIG. 3, when making a screen scroll upward, address data one line upper than the currently displayed address data. In a disassemble window, when displaying a command one step prior to a currently displayed command, a code one address prior to the current address is obtained. When the code cannot be transformed or converted into a specific command, a code two steps prior to a currently displayed command is also obtained together with the code one step prior to the currently displayed command. Those two codes are used to carrying out disassemble. If such a disassembling process is successfully performed, it would be detected whether the number of codes which should be used originally for the disassembled command is equal to the number of codes which actually went back about the called-for command. When it is not equal, it also uses the code three address prior to the current, and performs disassemble process again.

According to another aspect of the present invention, in a disassemble window, a disassembling process goes back by steps corresponding to the number of the maximum codes from the currently displayed command. If the number of the maximum codes of a micro-controller is three, disassemble processing is first started from the code three addresses prior to the current address. When the code cannot be transformed into a specific command, disassemble processing is started from the code two addresses prior to the current address. This process is repeated until a disassemble process is successful or this operation is repeated to the code one address prior to the current address.

If a disassemble process is successfully carried out, it will detects whether the number of codes which should originally be used is equal to the actually used number of codes. When this result is equal, and processing is ended when the code one address prior to the current address is used for the disassemble process.

According to still another aspect of the present invention, a print file corresponding to display data of a disassemble window is prepared in advance to generate a command head information table. The disassemble start address is determined in accordance with the generated command head information.

This invention does not have the necessity of performing disassemble processing from the head of code memory. Therefore, even if it scrolls on one line in the state where near the last address is displayed in the display window, a display will be possible by the few number of times of disassemble processing.

First Preferred Embodiment

FIG. 4 is a diagram showing the contents of a code memory 14 according to a first preferred embodiment of the present invention. The code memory 14 is a memory in which command codes, displayed in a disassemble window of a debugger are stored. The code memory 14 stores address data 19 which begins from oth, and command or instruction code data 20 corresponding to each address.

An area 18 is displayed in a disassemble window. As shown in FIG. 3, the disassemble window also displays disassembled data corresponding to each command code 20. By scrolling the disassemble display window up and down, the address newly displayed and corresponding command code are transformed and displayed in the disassemble window. In addition, according to this embodiment, scrolling is moving a cursor of a window in the direction of the address from larger to smaller.

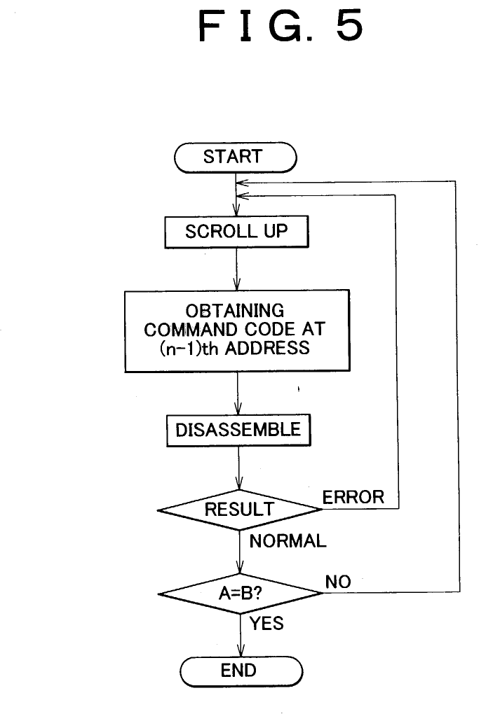

FIG. 5 shows a flow chart showing the operation of the first preferred embodiment. When the disassemble window is scrolled upward, it will go back, and it will carry out a disassemble process to a command data corresponding to one address smaller than the currently displayed addresses.

When the disassemble window is scrolled upwardly, a command code 17, corresponding to an address one step smaller than the currently displayed addresses, is obtained from a code memory 14. The obtained command code 17 is disassembled. A disassemble processing is one function. An address, a command code and a buffer for storing character data are specified as input of a function. The result transformed by the function is stored in the buffer. It is judged by the return value of a function whether disassemble processing was completed normally. For example, it would be judged that the disassemble processing was completed normally, if the return value of the function is zero. On the other hand, if the return value of the function is not zero, it would be judged that the disassemble processing was no completed normally. Here, having ended normally shows a success of disassemble processing and a command is displayed on a window. Moreover, it is shown that this error of the transformation of the code by disassemble processing was not completed.

When the above-mentioned disassemble processing is an error, a disassemble process goes back one more address, and acquires a code 16 of the address two prior to the current address. It is deemed that the two codes 16 and 17 form a single command code, to which another disassemble process is carried out.

On the other hand, when the above-mentioned disassemble processing is successful, the number of codes, which should be used originally for the disassembled command is compared with the number of the addresses which actually went back. When the number of codes, which should be used originally for the disassembled command, is equal to the number of the addresses, which actually went back, this transformation processing is ended and the disassembled command is displayed on a window. When the number of codes, which should be used originally for the disassembled command, is not equal to the number of the addresses, which actually went back, the code which went back one address is acquired. The firstly used command code and a current command code corresponding to the currently obtained address are treated as a single command code. The above-described process is repeated.

According to the present invention, a command of a micro-controller includes both a command composed of a single code and a command composed of a plurality of codes. For example, a MOV command is composed of two codes, and a JMP command is composed of four codes. If a command of a micro-controller is composed of one of among one to five addresses, the maximum number of code would be five.

According to the first preferred embodiment, the number of times which carries out disassembling process is the same number of times as many and this number of the maximum codes. That is because, a disassembling process is not carried out at times more than the maximum codes.

In the first preferred embodiment, the number of times of disassemble processing when the disassemble window is scrolled upwardly is not more than the maximum codes of a command, from the micro-controller. Therefore, the useless number of times of disassemble can be cut down, and the scroll processing velocity of a disassemble window can be improved.

Second Preferred Embodiment

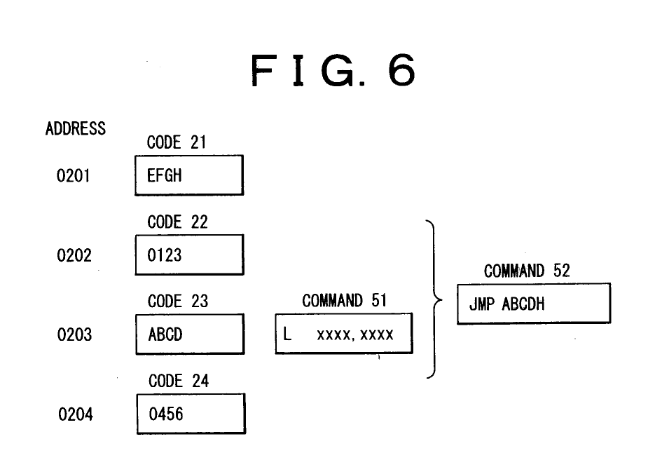

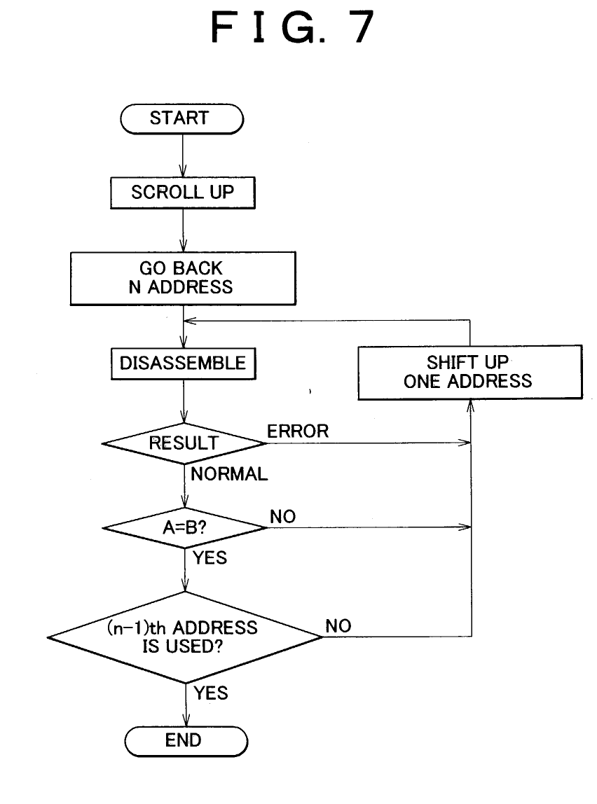

FIG. 6 shows contents of a code memory and according to a second preferred embodiment of the invention. FIG. 7 is a flow chart showing the operation of the second preferred embodiment. In this embodiment, description of the same or corresponding components and operation to those in the first preferred embodiment is not repeated.

One in the code constituted in a command code, which consists of two or more codes, may become the code same by chance as other command codes. A jump command 52 consists of a command code 22 and a command code 23, which indicating an address for jumping to. An address “0201” is the last line of the command code, which consists of two or more codes. An address “0204” shows an address currently displayed with a cursor. In addition, the command code 23 at an address “0203” is the same as a command code at others by chance. The number of the maximum codes of the micro-controller is set to three.

When a disassemble window is scrolled upwardly, the processing goes back by three addresses, which is equivalent to the number of the maximum codes of the micro-controller.

A disassemble process starts with a command code 21. If the disassemble process is normal, a next processing would be carried out. If the disassemble process is an error, an address one larger than the current is designated, then a disassemble process is restarted therefrom. In the case of FIG. 6, since the command code 21 at the address “0201” is the last line of the command code, which consists of two or more codes, a disassemble result serves as an error. By this result, an address “0202” one larger than the address “0201” is designated, and then, a disassemble process is restarted. Since a right command 52 consists of the address “0202” and the address “0203,” a disassemble process is completed normally.

According to this embodiment, the number of codes “A” required for the command is compared with the number of the addresses “B” used for disassemble, after disassemble is completed normally. When the result of comparison is not equal, an address one larger than the current address is designated, and a disassemble process is restarted. When the result of comparison is equal, a next processing is carried out. In the case of FIG. 6, since the result of comparison is equal, it moves to the next processing.

When the result of the above-mentioned comparison is equal, it is detected whether the address “(n−1)th one smaller than the current address “nth” indicated by a cursor was used in the disassemble process. If the “(n−1)th” address was not used for the disassemble process, an address one larger than the current address is designated, and a disassemble process is restarted. Since two or more addresses may have been used for the last processing here, an address one large than the current address is designated. On the other hand, if the “(n−2)th” address was used for the last disassemble process, the disassemble process would be completed and the disassembled command would be displayed on a disassemble window. In the case of FIG. 6, it is detected whether the address “0203” one smaller than the current address “0204” with the cursor was used for the disassemble process. In this case, since the address “0203” was used, the disassemble process is ended and the disassembled command 52 is displayed in the disassemble window.

According to the second preferred embodiment, a mistaken disassemble result is not displayed on a disassemble window, even if the code 2nd after the command, which consists of two or more codes, is a code in which disassemble is possible by chance.

Third Preferred Embodiment

According to a third preferred embodiment, when a program file is obtained or acquired, a print file is also obtained, and command head information is generated in accordance with the contents of the print file. The command head information is stored in a memory as a table. A start address of disassemble processing is determined in accordance with the table.

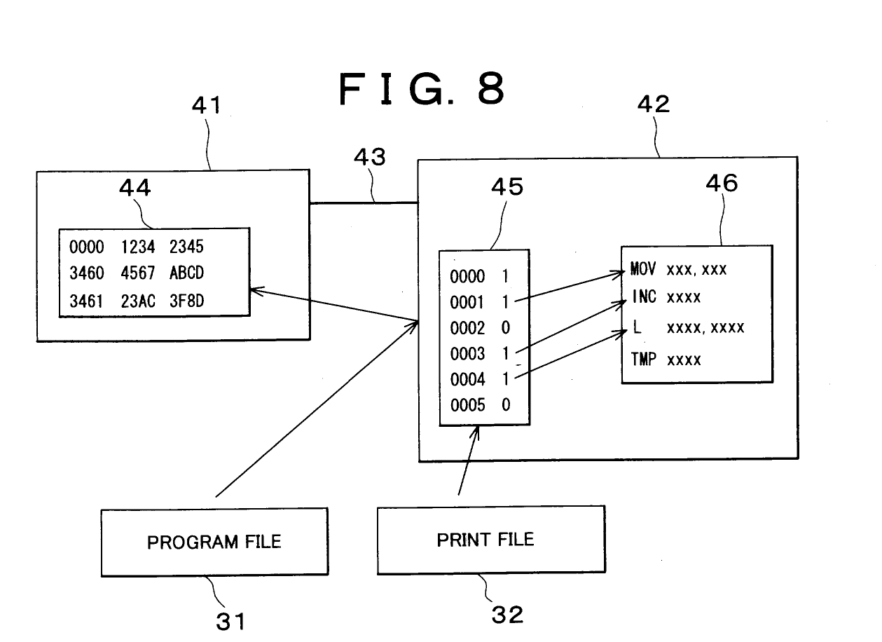

FIG. 8 shows a system according to the third preferred embodiment. The system includes an in-circuit emulator 41 and a debugger 42. The in-circuit emulator 41 includes a code memory 44. The debugger 42 includes a command head information table 45 and a disassemble window 46. The in-circuit emulator 41 and the debugger 42 are connected by a communication line 43. In this embodiment, description of the same or corresponding components and operation to those in the first and second preferred embodiments is not repeated.

The code memory 44 stores contents of a program file 31, which is downloaded via the communication line 43. A print file 32 is outputted when the program file 31 is produced using an assembler (not shown). The print file 32 includes address data, a command code and a command data. The contents of the print file 32 are equivalent to information displayed in the disassemble window 46.

The command head information table 45 is stored in a memory secured by the debugger 42. When reading the program file 31, the debugger 42 reads out the print file 32. Based on the print file 32, command head information, which indicating whether the address is a head of a command, is stored in the command head information table 45. The command head information table 45 stores command head information for all the addresses of the code memory 44.

The contents of the code memory 44 of an in-circuit emulator 41 are displayed on the disassemble window 46 using the data of the command head information table 45.

The debugger 42 starts disassemble processing with the head address of the command displayed in the disassemble window 46. The debugger 42 performs a disassemble process to a command code of and address one smaller than a head address of a command, which follows an address displayed at the last line in the disassemble window 46. The debugger 42 displays a disassemble result on the disassemble window 46.

When the disassemble window 46 is scrolled upwardly, the debugger 42 is supplied with a command head address one prior to the upper most address, which is currently displayed in the disassemble window 46, from the command head information table 45. The command code corresponding to this address is acquired from the code memory 44, and it performs disassemble processing.

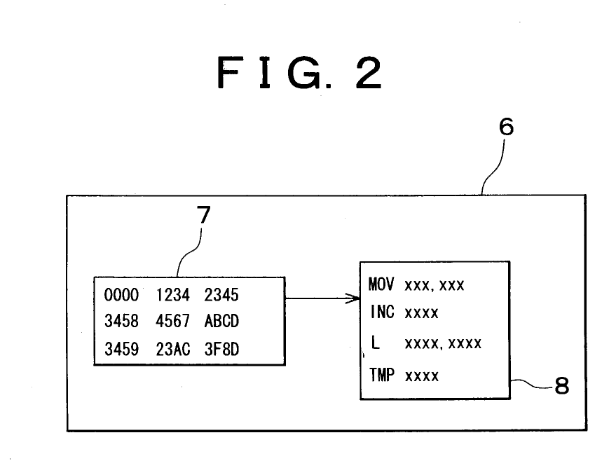

Now referring to FIG. 2, according to this embodiment, the simulator 6 may include the command head information table 45 therein. Disassemble processing of the simulator 6 is the same as the debugger 42.

According to this embodiment, the disassemble window 46 displays information in accordance with the print file 32, so that disassemble processing can be carried out reliably. Moreover, even when the disassemble window 46 is scrolled upwardly, only the necessary minimum (one time) number of times of disassemble is needed. Furthermore, velocity of scroll processing is improved.

What is claimed is:

1. A method for disassembling a command code of a micro-controller comprising:
displaying information comprising command codes, addresses of those command codes and disassembled commands of the command codes, in which (N)th to (N+n)th addresses are displayed; and
performing a disassemble process to a command code corresponding to a (N−1)th address when the displayed information is scrolled in a direction from a larger address to a smaller address.

2. A method according to claim 1, wherein:
detecting whether the disassemble process is completed normally.

3. A method according to claim 2, further comprising:
performing another disassembling process to a command code corresponding to (N−2)th address, when the disassemble process to the command code corresponding to the (N−1)th address is not completed normally.

4. A method according to claim 2, further comprising:
comparing the number of codes which should be used originally for the disassembled command and the number of codes which actually went back for the disassemble process.

5. A method according to claim 4, wherein
the comparison process is repeated a specific times in maximum, which are corresponding to the maximum number of command codes of the micro-controller.

6. A method for disassembling command code of a micro-controller comprising:
displaying information comprising command codes, addresses of those command codes and disassembled commands of the command codes, in which (N)th to (N+n)th addresses are displayed; and
starting a disassembling process with a command code corresponding to an address “A” steps prior to the (N)th address, when the displayed information is scrolled in a direction from a larger address to a smaller address, wherein
“A” is the maximum number of command codes of the micro-controller.

7. A method according to claim 6, further comprising:
detecting whether the disassemble process is completed normally.

8. A method according to claim 7, further comprising:
performing another disassembling process to a command code corresponding to an address one larger than a current address, when the previous disassemble process is not completed normally.

9. A method according to claim 7, further comprising:
comparing the number of codes which should be used originally for the disassembled command and the number of codes which actually went back for the disassemble process, if the previous disassemble process is completed normally.

10. A method according to claim 9, further comprising:
ending the disassemble process when the number of codes which should be used originally for the disassembled command and the number of codes which actually went back for the disassemble process are equal and a command code corresponding to an address one smaller than the current address was actually used for the disassembling process.

11. A method for disassembling command code of a micro-controller comprising:
displaying information comprising command codes, addresses of those command codes and disassembled commands of the command codes;
displaying information comprising addresses, command codes and disassembled commands;
providing program which comprises a command code and an address;
providing a print file, which comprising data corresponding to the displayed information;
generating a command head information in accordance with the print file; and
generating a start address for a disassemble process in accordance with the command head information.

12. A method according to claim 11, further comprising:
storing the command head information as a table.
